(19) United States
(12) Patent Application Publication
(10) Pub. No.: US 2015/0205372 A1
(43) Pub. Date: Jul. 23, 2015

(54) METHOD AND APPARATUS FOR PROVIDING INPUT INTERFACE FOR MOBILE TERMINAL

(71) Applicant: Samsung Electronics Co., Ltd., Suwon-si (KR)

(72) Inventors: Min Soo KIM, Gumi-si (KR); Soon Sang PARK, Daegu (KR); Ji Woong OH, Gumi-si (KR); Tae Hwan WI, Suwon-si (KR); Yong Ju LEE, Daegu (KR); Hyun Suk CHOI, Daegu (KR)

(21) Appl. No.: 14/579,124

(22) Filed: Dec. 22, 2014

(30) Foreign Application Priority Data
Jan. 22, 2014 (KR) 10-2014-0007873

(51) Int. Cl. G06F 3/03; G06F 3/02

(52) U.S. Cl. CPC G06F 3/0304; G06F 3/0227

(57) ABSTRACT

A method of providing an input interface for a portable terminal is provided. The method includes capturing an input tool located on a rear of the portable terminal, wherein an input interface is displayed on the portable terminal, displaying the input tool on the input interface, and processing an input corresponding to an input unit based on a motion of the input tool relative to the input unit of the input interface.

### CROSS-REFERENCE TO RELATED APPLICATION(S)

The application claims the benefit under 35 U.S.C. §119(a) of a Korean patent application filed on Jan. 22, 2014 in the Korean Intellectual Property Office and assigned Serial number 10-2014-0007873, the entire disclosure of which is hereby incorporated by reference.

### TECHNICAL FIELD

The present disclosure relates to a method of detecting an operation and performing an input operation by using a camera of a portable terminal. More particularly, the present disclosure relates to a technique for detecting and analyzing a user operation by using a captured image and determining whether the operation is an intentional input, when data transmitted from a camera is being displayed on a screen of the portable terminal.

### BACKGROUND

A portable terminal, such as a smart phone or a tablet, supports various functions, such as an interne search, broadcasting reception, and moving picture reproduction, in addition to a wireless call function. Recently released portable terminals support a soft keyboard that is displayed on a screen and allows an input through a user touch, instead of a physical keyboard. Input interfaces such as qwerty-type keyboards, 4×3 matrix keypads and various types of input interfaces supported by various applications are provided. A user may touch an input unit at a point where a specific character or number is displayed, and enter a desired character or number.

Electronic devices such as portable terminals have recently been released that fundamentally include camera modules. A camera module may include a front camera module that may take an image of a user (namely, the front of the electronic device) who is viewing the electronic device, and a rear camera module that may take an image of the rear of the electronic device. Images captured by the camera module may be displayed on the screen of the electronic device and the user may store the displayed images as still images or record them as moving pictures.

FIGS. 1A and 1B represent a limitation when performing an input by touching a screen according to the related art.

Referring to FIGS. 1A and 1B, in the case of a portable terminal, a user input tool such as a hand needs to be in contacted with a screen to allow a user to touch the screen, and in this case, a large portion of an input interface does not appear because it is hidden by the hand, as shown in FIG. 1A. This may act as an obstacle in rapidly inputting data or commands.

Also, since the size of the screen is limited, an input interface including a plurality of input units such as a QWERTY keyboard is displayed with a significantly decreased size. As shown in FIG. 1B, while an input unit (key) is displayed in a narrow area, an input tool such as a user's finger has a wider touch area than the area of the input unit, and thus a key not intended by a user may be input, or the frequency of incorrect inputs may increase.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus for sensing a motion of an input tool captured from the rear of a portable terminal, analyzing a corresponding image change to determine a user's input intention, minimizing obstacles in the user's input and decreasing the number of incorrect inputs.

In accordance with an aspect of the present disclosure, a method for an input interface for a portable terminal is provided. The method includes capturing an input tool located on a rear of the portable terminal, wherein an input interface is displayed on the portable terminal, displaying the input tool on the input interface, and processing an input corresponding to an input unit based on a motion of the input tool relative to the input unit of the input interface.

In accordance with another aspect of the present disclosure, a portable terminal for an input interface by using a camera is provided. The portable terminal includes a capturing unit configured to capture an input tool located on a rear of the portable terminal, a control unit configured to obtain image information on the input tool from the capturing unit, a display unit configured to receive the image information from the control unit and to display the input interface and the input tool, and an image analysis unit configured to receive the image information from the control unit, to determine a user input intended by the input tool based on the image information, and to provide a determination result to the control unit.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIGS. 1A and 1B represent a limitation when performing an input by touching a screen according to the related art.

FIG. 2 represents an input interface of a portable terminal according to an embodiment of the present disclosure.

FIGS. 3A, 3B, and 3C represent examples of displaying an input unit and an input tool according to an embodiment of the present disclosure.

FIGS. 4A, 4B, 4C, and 4D represent methods of displaying an input interface according to an embodiment of the present disclosure.

FIGS. 5A and 5B represent methods of processing an input according to an embodiment of the present disclosure.

FIG. 6 represents a method of changing a location of an input interface according to an embodiment of the present disclosure.

FIG. 7 represents a structure of a portable terminal according to an embodiment of the present disclosure.

FIG. 8 represents a structure of an electronic device according to an embodiment of the present disclosure.

FIG. 9 represents a flow chart of a method of providing an input interface according to an embodiment of the present disclosure.

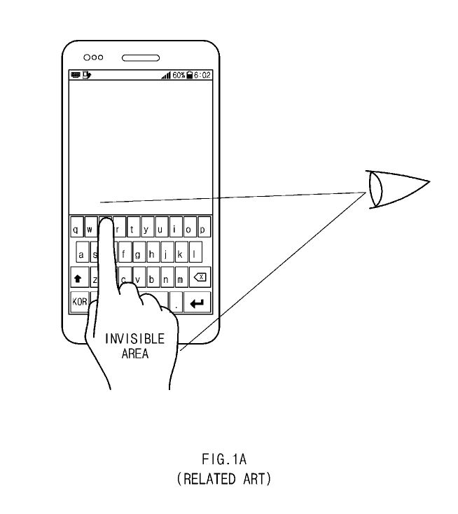

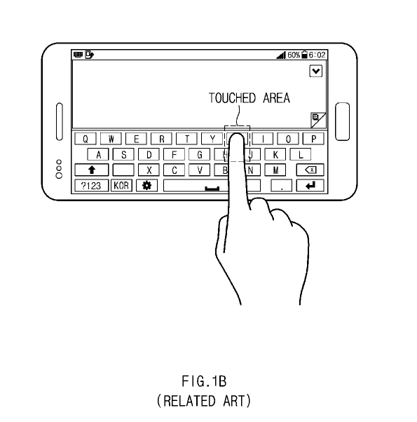

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purposes only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expression “a first”, “a second”, “firstly”, or “secondly” in the present disclosure may modify various components of the present disclosure but does not limit corresponding components. For example, the expressions above do not limit the order and/or importance of corresponding components. The expressions above may be used to distinguish one component from another component. For example, a first user device and a second user device are both user devices but represent different user devices. For example, without departing from the scope of rights of the present disclosure, a first component may be called a second component and similarly, the second component may also be called the first component.

When any component is referred to as being ‘connected’ to another component, it should be understood that the former can be ‘directly connected’ to the latter, or there may be another component in between. On the contrary, when any component is referred to as being ‘directly connected’ to another component, it should be understood that there may be no other component in between.

The terms used herein are only used to describe specific various embodiments and not intended to limit the present disclosure. The terms in singular form may include the plural form unless otherwise specified.

Unless otherwise defined herein, all terms used herein including technical or scientific terms have the same meanings as those generally understood by a person skilled in the art. Terms defined in generally used dictionaries should be construed to have meanings matching contextual meanings in the related art and should not be construed as having an ideal or excessively formal meaning unless otherwise defined herein.

An electronic device according to the present disclosure may be a device that includes a communication function. For example, the electronic device may include at least one of a smart phone, a tablet Personal Computer (PC), a mobile phone, a video phone, an e-book reader, a desktop PC, a laptop PC, a net book computer, a Personal Digital Assistant (PDA), a Portable Multimedia Player (PMP), an MP3 player, a mobile medical device, a camera, and a wearable device (e.g., a Head-Mounted-Device (HMD) such as electronic glasses, electronic clothing, an electronic bracelet, an electronic necklace, an electronic appcessory, an electronic tattoo, or a smart watch).

According to some various embodiments, the electronic device may be a smart home appliance having a communication function. The smart home appliance may include, for example, at least one of a TV set, a Digital Video Disk (DVD) player, an audio set, a refrigerator, an air conditioner, a cleaner, an oven, a microwave oven, a washing machine, an air cleaner, a set-top box, a TV box (e.g., Samsung HomeSync™, Apple TV™, or Google TV™), a game console, an electronic dictionary, an electronic key, a camcorder, and an electronic frame.

According to some various embodiments, the electronic device may include at least one of various medical devices (e.g., a Magnetic Resonance Angiography (MRA) device, a Magnetic Resonance Imaging (MRI) device, a Computed Tomography (CT) device, a camera, and an ultrasonicator), a navigator, a Global Positioning System (GPS) receiver, an Event Data Recorder (EDR), a Flight Data Recorder (FDR), a car infotainment device, electronic equipment for a ship (e.g., a navigator for a ship or a gyro compass), avionics, a security device, a head unit for a car, an industrial or home robot, a financial institution's Automated Teller Machine (ATM) and a store's Point Of Sales (POS).

According to some various embodiments, the electronic device may include at least one of a portion of a building/structure or furniture including a communication function, an electronic board, an electronic signature receiving device, a projector, and various measurement devices (e.g., a water, electricity, gas or electric wave measurement device). An electronic device according to the present disclosure may be one or more combinations of the above-described various devices. An electronic device according to the present disclosure may be a flexible device. Similarly, an electronic device according to the present disclosure is not limited to the above-described devices.

Electronic devices according to various embodiments are described below with reference to the accompanying drawings. The term “user” used in various embodiments may refer to a person who uses an electronic device, or a device (e.g., an electronic device having artificial intelligence) that uses an electronic device.

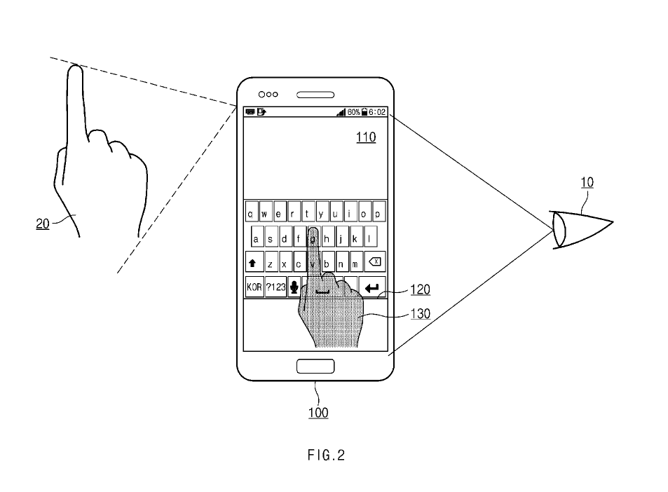

FIG. 2 represents an input interface of a portable terminal according to an embodiment of the present disclosure.

Referring to FIG. 2, an input interface 120 such as a QWERTY keyboard may be displayed on a screen 110 of a portable terminal 100. The portable terminal 100 may include a rear camera (not shown). A front camera may be located on the same surface as the screen 110 of the portable terminal 100 and take an image of a subject located on the front of the portable terminal 100, such as a user's face. The rear camera may be located on the opposite surface to the screen 110 of the portable terminal 100 and take an image of a subject located on the rear of the portable terminal 100, such as a user's hand 20. The user's eye 10 may see the screen 110 of the portable terminal 100 and an image 130 of the user's hand 20 captured by the portable terminal 100 may be displayed on the screen 110. There may be no object between the user's eye 10 and the screen 110 and thus when the user performs an input operation, an input interface 120 may not be hidden by a user input tool such as the user's hand 20.

Images captured by the camera may include both the user's hand 20 and a background image where the user's hand 20 is located, but only the image 130 corresponding to the user's hand 20 may be displayed for inputting convenience. For such a display, the control unit (e.g., CPU, GPU, Application Processor (AP), or other image analysis modules) of the portable terminal 100 may analyze a background image including the user's hand 20 and leave only an image corresponding to the user's hand 20 through filtering. The control unit may perform a filter operation based on a known input tool such as a user's hand or a stylus and alternatively may also perform a filter operation by using hand's characteristics such as skin colors, nails or finger joint wrinkles.

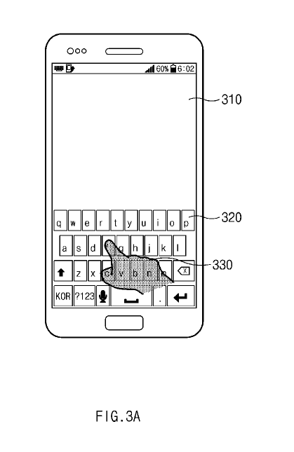

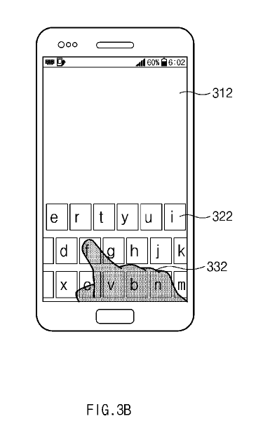

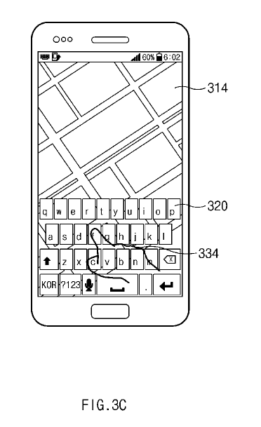

The input tool captured by the rear camera of the portable terminal 100 may be displayed on the screen 110. The input tool displayed may be re-sized. For example, when the user's hand 20 is captured through a camera application, the size of the user's hand appearing on the screen 110 may vary depending on the distance between the camera (portable terminal 100) and the user's hand 20. However, the size of an input unit configuring the input interface 120 may be fixed by the width of the screen 110. For an accurate input, the size of the input tool displayed may correspond to or be smaller than that of the input unit. If the distance between the user's hand 20 and the portable terminal 100 is too close and thus the size of the hand displayed on the screen 110 is too large, the hand (image 130) may be located (displayed) on portions corresponding to a plurality of input units, and an input corresponding to an input key not intended by a user among the plurality of input units may be performed when the user performs an input operation. Related examples are shown in FIG. 3.

FIGS. 3A to 3C represent examples of displaying an input tool and an input interface according to an embodiment of the present disclosure.

Referring to FIGS. 3A-3C, a QWERTY keyboard 320 is displayed on a screen 310. An image of the user's hand 20 captured by the portable terminal 100 may be resized and displayed based on the size of each key (i.e., input unit) configuring the QWERTY keyboard 320. For example, when a portion corresponding to one key includes 20×30 pixels, the user's hand 330 displayed may be resized so that the size of a user's fingertip (e.g., last joint or nail portion of an index finger) is smaller than or equal to the 20×30 pixels. The size of the user's hand 330 displayed may be smaller or larger than a captured image.

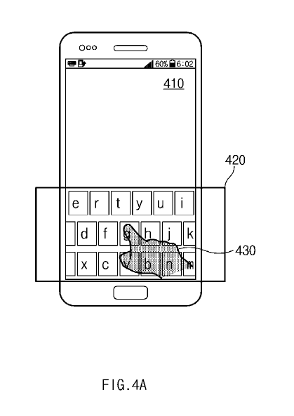

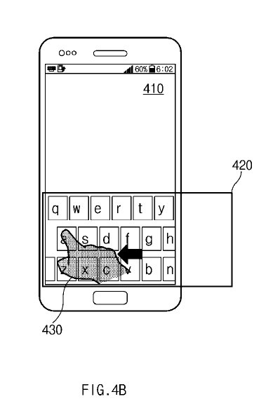

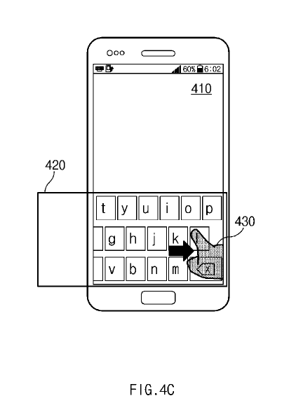

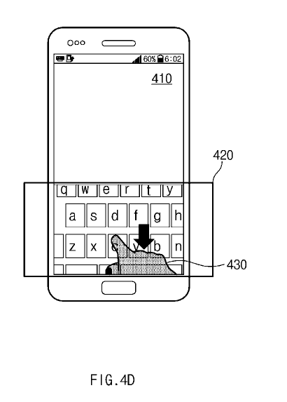

Referring to FIG. 3B, the size of the user's hand 332 displayed may be equal to that of a captured image. In this case, an input interface 322 may be resized and displayed in proportion to the size of the user's hand 332. If the size of the user's hand 332 is larger than that shown in FIG. 3A (e.g., the size of a portion corresponding to an input point of the user's hand 332 correspond to 50×50 pixels), a keyboard 322 may be expanded so that the size of the input unit is larger than 50×50 pixels. In this case, the input interface (i.e., keyboard 322) may not be entirely displayed on the screen 312. Portions not displayed may be displayed according to the location and movement of the input tool (in this case, the user's hand). Related descriptions are provided with reference to FIGS. 4A to 4D.

When the distance between the input tool and the camera is sufficiently long and thus the portion of an input point is sufficiently smaller than that of an input unit configuring the input interface 322, the input interface 322 may be resized until the entire input keyboard is displayed. In the example shown in FIG. 3B, as the user's hand recedes from the portable terminal, the size of the expanded keyboard gradually decreases, but after all the keys are displayed as shown in FIG. 3A, there may be no further decrease.

The input tool may be displayed in a translucent state in order not to impede the display of the input interface. The input interface may be displayed in a translucent state as well. The transparency of the input interface and the input tool may be set up differently. As shown in FIG. 3C, the input tool may be displayed on the screen 314 as a guide line representing the border of the input tool, not an image that is obtained by capturing the input tool. In such an embodiment, the input tool may enable a user to easily recognize the input unit without hiding the displayed input interface.

When the input tool is located on a certain input unit (e.g., a user's index finger tip is located on a portion corresponding to a certain key), the color or transparency of a corresponding input unit may be adjusted, and thus a point where the input tool is currently located becomes clear.

FIGS. 4A to 4D represent methods of displaying an input interface according to an embodiment of the present disclosure.

Referring to FIGS. 4A to 4D, the input interface is expanded based on the size of a captured user input tool, and a portion of the entire input interface may be displayed on a screen 410. A portion of the input interface initially displayed may be defined by using various methods. For example, a specific input unit may be located on an input point (e.g., an index finger tip or a stylus tip) of a user input tool 430 displayed. The specific input unit may be a keyboard's reference key (e.g., a key “F” or “J”) or a key located on the central part of the input interface (in the case of a QWERTY keyboard, a key “G” or “H”, and in the case of a numeric keypad, a key located on the central part such as a key “5”).

The input interface 420 may move in proportion to the travel distance of the input tool. When the portable terminal is located in a longitudinal direction, the longitudinal travel of the input tool may be ignored. The input interface 420 may move only in a transverse direction irrespective of the longitudinal travel of the input tool. However, as shown in FIG. 4D, the input interface 420 may move in the longitudinal direction. In this case, the transverse travel of the input interface 420 may be fixed or it may move transversely and longitudinally (i.e., diagonally).

A displayed input tool image 430 moves in the screen 410, while the travel distance of the input interface 420 may be longer than that of the input tool image 430 because the width of the input interface 420 is wider than that of the screen 410. In the opposite case, portions of the input interface 420 not displayed are not displayed even if the input tool image 430 moves to one end of the screen. As shown in FIG. 4B, when the input tool image 430 moves to the left (a user hand moves to the left), the input interface 420 may move to the right that is opposite to the travel direction of the input tool. By such a movement, the left portion of the input interface 420 not displayed on the screen may be displayed. When the input tool image 430 moves to the right as shown in FIG. 4C, the same description may also be applied.

The input interface 420 may move in proportion to the travel distance of the input tool image 430. For example, when the input tool image 430 is located on the left border area of the screen 410, a movement may be performed so that the left border of the input interface 420 is located on the left border of the screen 410. (The same goes for right or upper and lower borders.) In another example, the travel distance of the input interface 420 moves at a higher ratio than that of the input tool image 430, and remaining portions not displayed on the screen before the input tool image 430 reaches a border may all be displayed.

In various embodiments, when the input tool 430 is located on the border of the interface 420 displayed or the border of the screen 410, the interface 420 may move in order to display the remaining portions of the interface 420 not displayed on the screen 410. For example, in FIG. 4A, when the input tool 430 is located on the left border of the screen 410, the input interface 420 may move in order to display the remaining left portion not displayed on the screen 410.

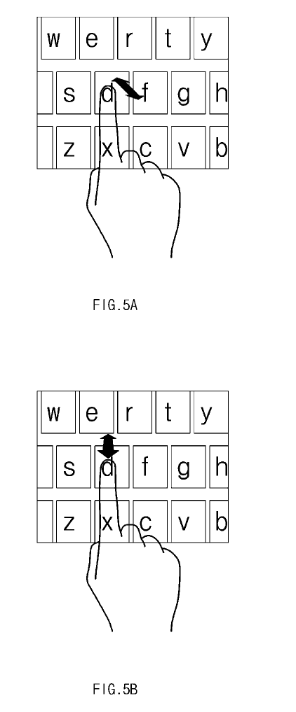

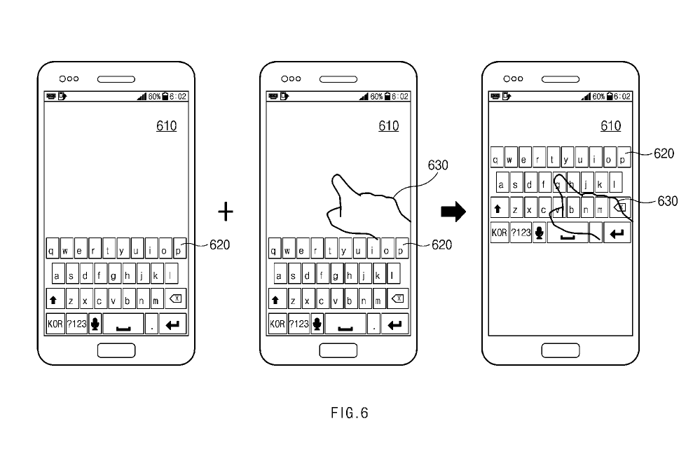

FIGS. 5A and 5B represent methods of processing an input according to an embodiment of the present disclosure.

Referring to FIGS. 5A and 5B, the portable terminal 100 may capture a motion of the input tool and determine an input intended by a user. Generally, an input through an input interface such as a keyboard displayed on a screen is performed through an operation of tapping or clicking a specific key. Accordingly, a user may perform an input by using a user input tool (e.g., a finger or stylus) on the rear of the portable terminal 100. For example, as shown in FIG. 5A, when an input tool image is located on a key “D” of an input interface, then deviates from the key “D”, and returns to the key “D”, the portable terminal may determine that an input for the key “D” is performed. However, the user input tool image may not deviate from a portion corresponding to the key “D” even though a user performs a tapping or clicking operation while locating a user input tool image on a specific input unit. In such a case, when a perspective of a hand image on a key to be input varies as shown in FIG. 5B for example, the portable terminal 100 may determine such a variation in perspective as an input operation and allow a corresponding key (in this case, a key “D”) to be input. In a variation, when an input tool image stays for a certain time (e.g., one second) on a specific key to be input, an input for the key to be input may be performed.

FIG. 6 represents a method of changing a location of an input interface according to an embodiment according to the present disclosure.

Referring to FIG. 6, an input interface 620 such as a keyboard may be displayed on the lower part of a screen 610 of a portable terminal. The input interface 620 may be displayed with different input keyboard arrangements on different locations, according to the characteristics of an application or an electronic device.

Then, a user input tool located on the rear of the portable terminal may be captured and analyzed by a camera, and may be displayed on the screen 610. Since the user input tool may be freely located on the rear of the portable terminal, it may be displayed on any point of the screen 610 and may also be located outside an area corresponding to the input interface 620.

The portable terminal may compare the displayed locations of a user input tool image 630, which is obtained through being captured and displayed, and the input interface 620, and when the input tool image 630 is outside an area corresponding to the input interface 620, the portable terminal may move the input interface 620. In the example shown, the input interface 620 may be scrolled up to a point where the input tool image 630 is located.

As a result of moving the input interface 620, a certain portion of the input interface 620 may be mapped to a certain portion of the input tool image 630. For example, a movement may be performed so that the longitudinal center (e.g., a portion where keys ASDFGHJKL; are arranged in the case of QWERTY keyboard) of the input interface 620 is located on a portion (e.g., an index finger tip or a stylus tip) of the input tool image that is determined as an input point. However, when the input point of the input tool image 630 is not the central portion (e.g., an area [ASDFGHJKL;]) of the input interface but is in the input interface 620, a user may expect the input interface 620 not to move, and the input interface 620 may stop on the initial location. In this state, when the input point moves to the outside of the input interface 620 by a certain distance, the location of the input interface 620 may be re-adjusted based on the location of the input point. By using such an operation, a user may perform an input while the longitudinal or transverse location of the input point located on the rear of an electronic device are arranged to be convenient for the input.

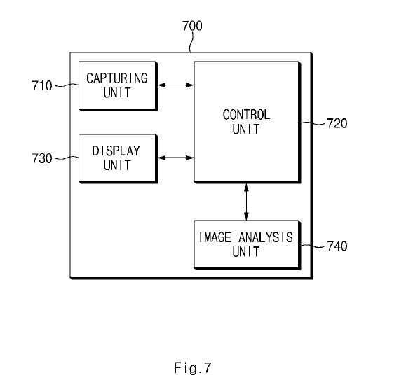

FIG. 7 represents a structure of a portable terminal according to an embodiment of the present disclosure.

Referring to FIG. 7, a portable terminal 700 may include a capturing unit 710, a control unit 720, a display unit 730, and an image analysis unit 740.

The capturing unit 710 may include a camera module that may capture the rear of the portable terminal 700, convert a captured image into an image signal, and transmit the signal to the control unit 720. In various embodiments of the present disclosure, the capturing unit 710 may capture a user input tool such as a user hand or stylus located on the rear of the portable terminal 700 and may transmit image information to the control unit 720.

The control unit 720 may obtain information on a captured image from the capturing unit 710 and provide the image information to the image analysis unit 740. The control unit 720 may receive analyzed data from the image analysis unit 740, may compare the received data with information on the original size of the input tool image, information on the display resolution of the portable terminal 710, and information on the size of the input interface displayed on the display unit 730, and may determine the size and location of an input tool image to be displayed. The control unit 720 may also adjust the location and size of the input interface.

The display unit 730 displays an image based on the information on an input interface and an input tool received from the control unit 720. The display unit 730 may be a display panel.

The image analysis unit 740 analyzes image information received from the control unit 720. The image analysis unit 740 may analyze the type of an input tool, the size and location of the input tool, and a location corresponding to an input point of the input tool, based on image information. The image analysis unit 740 may determine, based on the motion of the input tool, whether an input intended by a user is to move an input point or to input a specific key, and provide a determination result to the control unit 720.

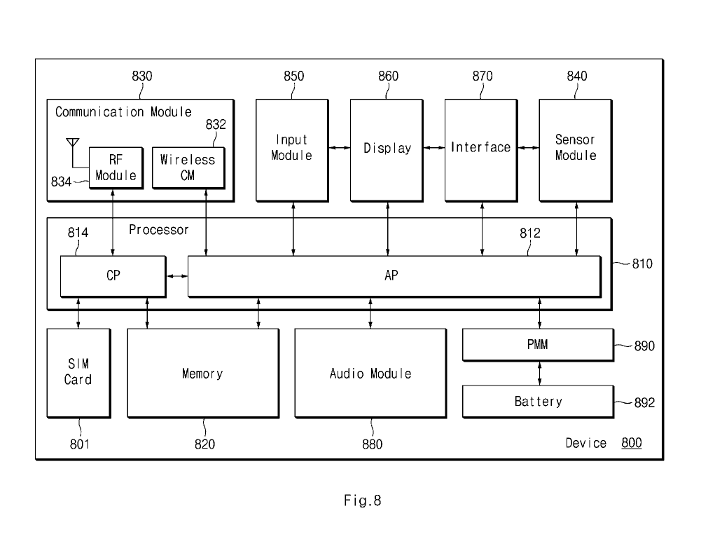

A configuration of the portable terminal 700 is not limited to the above description and may be expanded to more general electronic devices. For example, the portable terminal 700 may further include a power management module, activate the capturing unit 710 while the input interface is displayed on the display unit 730, and deactivate the capturing unit 710 if the input interface is not displayed, thereby minimizing power consumption. As another example, the portable terminal 700 may further include an inertia sensor that may sense shaking, an acceleration sensor and a gravity sensor, and when a user performs an input, shaking from a hand holding a device is sensed and corrected, and thus it is possible to enhance inputting accuracy. Expanded functions of an electronic device are described with reference to FIG. 8.

FIG. 8 represents a structure of an electronic device according to an embodiment of the present disclosure.

Referring to FIG. 8, an electronic device 800 may include a processor 810, a memory 820, a communication module 830, a sensor module 840, an input module 850, a display 860, an interface 870, an audio module 880, a Power Management Module (PMM) 890, a battery 892, and a SIM card 801.

The processor 810 may include one or more APs 812 and/or one or more Communication Processors (CPs) 814. FIG. 8 shows that the AP 812 and the CP 814 are included in the processor 810, but the AP 812 and the CP 814 may be included in different IC packages, respectively. According to an embodiment, the AP 812 and the CP 814 may be included in one IC package.

The AP 812 may execute operating system or application programs to control a plurality of hardware and software components connected to the AP 812 and may perform processing and calculation on various pieces of data including multimedia data. The AP 812 may be implemented as a System on Chip (SoC). According to an embodiment, the processor 810 may further include a Graphic Processing Unit (GPU).

The CP 814 may manage a data link during communicating between other electronic devices connected to an electronic device 800 over a network, and perform a function of converting a communication protocol. The CP 814 may be implanted as a SoC. In an embodiment, the CP 814 may perform at least some multimedia control functions. The CP may use a subscriber identification module (e.g., SIM card) to identify and authenticate electronic devices in a communication network. The CP 814 may also provide voice call, video call, text message and packet data services to a user.

The CP 814 may perform the data transmission/reception of the communication module 830. FIG. 8 shows components including the CP 814, the PMM 890 and the memory 820 separately from the AP 812, but according to an embodiment, the AP 812 may be implemented to include at least some (e.g., CP 814) of the above-described components.

The AP 812 or the CP 814 may load, on volatile memories, commands or data received from non-volatile memories connected to the AP 812 or the CP 814 or from at least one other component, and may process the commands or data. The AP 812 or the CP 814 may store, in non-volatile memories, data received from at least one of other components or generated by at least one of other components.

The SIM card 801 may be a card including a subscriber identification module and may be inserted into a slot that is formed on a specific part of an electronic device. The SIM card 801 may include unique identification information (e.g., Integrated Circuit Card IDentifier (ICCID)) or subscriber information (e.g., International Mobile Subscriber Identity (IMSI)).

The memory 820 may include an internal memory and/or external memory. The internal memory may include at least one of a volatile memory such as a DRAM, SRAM, or SDRAM, and a non-volatile memory such as an One Time Programmable ROM (OTPROM), PROM, EPROM, EEPROM, mask ROM, flash ROM, NAND flash memory, or NOR flash memory. The internal memory may be a Solid State Disk (SSD). The external memory may further include a flash drive such as a Compact Flash (CF) card, SD card, micro-SD card, mini-SD card, Xd card, or memory stick. The external memory may be functionally connected to the electronic device 800 through various interfaces. The electronic device 800 may further include a storage device (or storage medium) such as an HDD.

The communication module 830 may include a wireless communication module 832 and/or a Radio Frequency (RF) module 834. The wireless communication module 832 may include, for example, a Wi-Fi, Bluetooth, GPS, or Near Field Communication (NFC) module. The wireless communication module 832 may use a radio frequency to provide a wireless communication function. The wireless communication module 832 may include a network interface (e.g., LAN card) or modem for connecting the electronic device 800 to a network (e.g., Internet network, LAN, WAN, telecommunication network, cellular network, satellite network or Plain Old Telephone Service (POTS)).

The RF module 834 may be responsible for data communication such as the transmission and reception of an RF signal. The RF module 834 may include, for example, a transceiver, Power Amp Module (PAM), frequency filter or Low Noise Amplifier (LNA). The RF module 834 may further include a part such as a conductor or wire for transmitting or receiving electromagnetic waves in a free space when performing wireless communication. An antenna system may correspond to the RF module 834 or at least a portion configuring the RF module.

The sensor module 840 may measure a physical quantity, sense the operation state of the electronic device 800 and convert measured or sensed information into an electrical signal. The sensor module 840 may include at least one of a gesture sensor, a gyro sensor, an atmospheric pressure sensor, a magnetic sensor, an acceleration sensor, a grip sensor, a proximity sensor, a color sensor (e.g., an RGB sensor), a bio sensor, a temperature/humidity sensor, an illumination sensor and an Ultra Violet (UV) sensor. Also, the sensor module 840 may include a smell sensor, an ElectroMyoGraphy (EMG) sensor, an ElectroEncephaloGram (EEG) sensor, an ElectroCardioGram (ECG) sensor, an IR sensor, an iris sensor or a fingerprint sensor. The sensor module 840 may further include a control circuit for controlling at least one sensor.

The input module 850 may include a touch panel, a (digital) pen sensor, a key or an ultrasonic input device. The touch panel may recognize a touch input by using at least one of capacitive, pressure-sensitive, infrared or ultrasonic techniques, for example. The touch panel may further include a control circuit. In the case of the capacitive technique, a physical contact or proximity awareness is possible. The touch panel may further include a tactile layer. In this case, the touch panel may provide a tactile response to a user.

The display 860 may include a panel, a hologram, or a projector. For example, the panel may be a Liquid Crystal Display (LCD) or an Active Matrix Organic Light Emitting Diode (AMOLED). The panel may also be implemented flexibly, transparently, or wearably. The panel may be integrated into the touch panel to be configured in a module. The hologram may use the interference of a light to show a stereoscopic image in the air. The projector may project a light onto a screen to display an image. The screen may be located inside or outside the electronic device 800. The display 860 may further include a control circuit for controlling a panel, a hologram or a projector.

The interface 870 may include an HDMI, USB, optical communication terminal or D-sub terminal. Also, the interface 870 may include a Mobile High-definition Link (MHL), SD card/Multi-Media Card (MMC) or Infrared Data Association (IrDA) unit.

The audio module 880 may convert sound into an electrical signal or vice versa. The audio module 880 may process sound information input or output through a speaker, receiver, earphone or microphone.

The PMM 890 may manage the power of the electronic device 800. The PMM 890 may include a Power Management Integrated Circuit (PMIC), a charger IC, or a battery or fuel gauge.

The electronic device 800 according to various embodiments may include the sensor module 840 including a camera module. The camera module may include a rear camera module and further include a front camera module.

The electronic device 800 may include a processor 810 including at least one of the CP 814 and the AP 812. The processor 810 may work as a control unit controlling the overall function of the electronic device 800.

The electronic device 800 may include the display 860 to display a captured image and the input module 850. Through a component such as a touch panel display, the display 860 and the input module 850 may be implemented in a single component. By including such a configuration, various embodiments of the present disclosure may also be applied to a device such as a smart camera, in addition to a smart phone, a tablet or examples of the above-described electronic device.

The sensor module 840 may further include a module such as an inertia sensor that may sense the shaking of the electronic device 800. By performing correction on the shaking of the device by using such a module, it is possible to enhance the accuracy of a user input. It is also possible to decrease battery consumption by activating a camera module while an input interface is being displayed and by inactivating the camera module while the input interface is not being displayed.

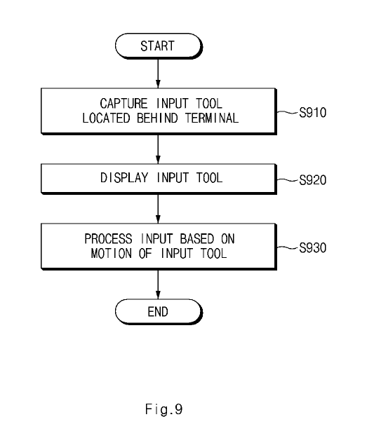

FIG. 9 represents a flow chart of a method of providing an input interface according to an embodiment of the present disclosure. In describing FIG. 9, descriptions that are the same or similar to those described above are left out.

Referring to FIG. 9, a user input tool located on the rear of a terminal is captured in operation S910. In this case, an input interface may be already displayed on the screen of the terminal In operation S920, a captured input tool is displayed on the input interface. In this example, being displayed on the input interface does not mean that the input tool is necessarily displayed in an area corresponding to the input interface, and may be understood that an input tool layer is displayed on an input interface layer. The input tool may also be displayed outside the input interface, and when the input tool is displayed in the area corresponding to the input interface, the input tool may appear on the input interface. Also, as described above, the input tool and the input interface may be displayed by using various methods such as transparency.

In operation S930, the terminal may continue to capture the input tool, and process an input for a specific input unit of the input interface where the input tool is located, based on a motion of a captured input tool.

According to various embodiments of the present disclosure, it is possible to process an input by analyzing a user's operation through an image captured by the rear camera and displayed on the screen and determining a user's intention. Accordingly, the present disclosure has an effect of solving the problem of an incorrect input occurring when a hand or tool to be used for an input that is located between the terminal and (the visual field of) the user hides the screen or the contact area of a hand to perform a touch input is wider than the area of an input unit of the input interface.

Also, according to various embodiments, the present disclosure has an effect of enabling a user to utilize various input methods by providing various User Interface/User eXperience (UI/UX) environments and further input techniques in addition to existing input tools.

Various aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include Read-Only Memory (ROM), Random-Access Memory (RAM), CD-ROMs, magnetic tapes, floppy disks, and optical data storage devices. The non-transitory computer readable recording medium can also be distributed over network coupled computer systems so that the computer readable code is stored and executed in a distributed fashion. Also, functional programs, code, and code segments for accomplishing the present disclosure can be easily construed by programmers skilled in the art to which the present disclosure pertains.

At this point it should be noted that various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include Read-Only Memory (ROM), Random-Access Memory (RAM), CD-ROMs, magnetic tapes, floppy disks, and optical data storage devices. The processor readable mediums can also be distributed over network coupled computer systems so that the instructions are stored and executed in a distributed fashion. Also, functional computer programs, instructions, and instruction segments for accomplishing the present disclosure can be easily construed by programmers skilled in the art to which the present disclosure pertains.

All the various embodiments and conditional examples disclosed herein are described to help a person skilled in the art to understand the principle and concepts of the present disclosure. It will be understood by a person skilled in the art that various changes in form may be made without departing from the spirit and scope of the present disclosure. Therefore, the disclosed various embodiments should be considered in a descriptive sense only and not for purposes of limitation. The scope of the present disclosure is defined not by the detailed description of the present disclosure but by the appended claims, and all differences within the scope will be construed as being included in the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of providing an input interface for a portable terminal, the method comprising:
capturing an input tool located on a rear of the portable terminal, wherein an input interface is displayed on the portable terminal;
displaying the input tool on the input interface; and
processing an input corresponding to an input unit based on a motion of the input tool relative to the input unit of the input interface.

2. The method according to claim 1, wherein the input interface is a keyboard and the input unit corresponds to a key included in the keyboard.

3. The method according to claim 1, wherein the input tool displayed is resized based on a size of the input unit.

4. The method according to claim 1, wherein, when a portion of the input interface is displayed, the input interface is resized based on a size of the input tool captured.

5. The method according to claim 4, wherein the resized input interface moves in proportion to a travel distance of the input tool.

6. The method according to claim 4, wherein, when the input tool is located on a border of a screen of the portable terminal, the resized input interface moves so that portions located outside the border are displayed.

7. The method according to claim 1, wherein at least one of the input tool and the input interface is displayed in a translucent manner.

8. The method according to claim 1, wherein the input tool is displayed on the input interface as a guide line that represents a border of the input tool.

9. The method according to claim 1, wherein the processing of the input comprises performing an input corresponding to the input unit when it is recognized that the input tool performs a tap operation on a location corresponding to the input unit.

10. The method according to claim 1, wherein the processing of the input comprises performing an input corresponding to the input unit when the input tool stays for a certain time on a location corresponding to the input unit.

11. The method according to claim 1, wherein the capturing of the input tool is performed while the input interface is displayed on the portable terminal.

12. The method according to claim 1, wherein a location of the input interface displayed is changed to correspond to a location on which the input tool captured is displayed.

13. A portable terminal configured to provide an input interface by using a camera, the portable terminal comprising:
a capturing unit configured to capture an input tool located on a rear of the portable terminal;
a control unit configured to obtain image information on the input tool from the capturing unit;
a display unit configured to receive the image information from the control unit and to display the input interface and the input tool; and
an image analysis unit configured to receive the image information from the control unit, to determine a user input intended by the input tool based on the image information, and to provide a determination result to the control unit.

14. The portable terminal according to claim 13, wherein the control unit adjusts at least one of the size of the captured input tool and the size of the input interface.

15. The portable terminal according to claim 13, further comprising a sensor configured to sense the shaking of the portable terminal, wherein the user input is corrected based on the shaking sensed by the sensor.

16. The portable terminal according to claim 15, wherein the sensor comprises one of an inertia sensor, an acceleration sensor, and a gravity sensor.

17. The portable terminal according to claim 12, wherein the control unit is further configured to deactivate the capturing unit while the input interface is not displayed on the display unit.
